(19) United States
(12) Patent Application Publication
(10) Pub. No.: US 2019/0286145 A1
(43) Pub. Date: Sep. 19, 2019

(54) Method and Apparatus for Dynamic Obstacle Avoidance by Mobile Robots

(71) Applicant: Omron Adept Technologies, Inc., San Ramon, CA (US)

(72) Inventors: Matthew LaFary, Livermore, CA (US); Daman Bareiss, Millcreek, UT (US)

(21) Appl. No.: 15/921,052

(22) Filed: Mar. 14, 2018

(51) Int. Cl. G05D 1/02; G05D 1/00

(52) U.S. Cl. CPC G05D 1/024; G05D 1/0221; G05D 1/0255; G01C 21/206; G05D 1/0291; Y10S 901/01; Y10S 901/47; G05D 1/0088

(57) ABSTRACT

According to disclosed methods and apparatus, a mobile robot moves autonomously along a planned path defined in a coordinate map of a working environment, and dynamically updates the planned path on an ongoing basis, to avoid detected obstacles and projections of detected obstacles. A “projection” arises in the context of moving obstacles detected by the mobile robot, at least in the case for a moving detected obstacle that meets certain minimum requirements, such as minimum speed, persistence, etc. The mobile robot makes a projection by, for example, marking map coordinates or map grid cells as occupied, based not only on the currently detected location of a moving obstacle but further on the most recent estimates of speed and direction. By feeding both detected locations and projections into its path planning algorithm, the mobile robot obtains sophisticated avoidance behavior with respect to moving obstacles.

### TECHNICAL FIELD

The present invention relates to mobile robots and particularly relates to dynamic obstacle avoidance by mobile robots.

### BACKGROUND

Mobile robots configured for autonomous travel enhance productivity and improve safety across a wide range of industrial and commercial applications. However, the proliferation of mobile robots, e.g., deployed in fleets, and the need for operating mobile robots in crowded deployment environments, e.g., in concert with other vehicles and workers, imposes increasingly sophisticated navigational challenges. One area of concern involves the avoidance of moving objects, because of the potentially significant computational burdens imposed on robotic control systems in the context of dynamic obstacle avoidance, and the need for robots to safely avoid both static and moving obstacles while making orderly and efficient advancement towards a targeted destination.

### SUMMARY

According to disclosed methods and apparatus, a mobile robot moves autonomously along a planned path defined in a coordinate map of a working environment, and dynamically updates the planned path on an ongoing basis, to avoid detected obstacles and projections of detected obstacles. A “projection” arises in the context of moving obstacles detected by the mobile robot, at least in the case for a moving detected obstacle that meets certain minimum requirements, such as minimum speed, persistence, etc. The mobile robot makes a projection by, for example, marking map coordinates or map grid cells as occupied, based not only on the currently detected location of a moving obstacle but further on the most recent estimates of speed and direction. By feeding both detected locations and projections into its path planning algorithm, the mobile robot obtains sophisticated avoidance behavior with respect to moving obstacles.

A mobile robot comprises, for example, one or more sensors configured for detecting obstacles within a defined sensory range of the mobile robot, a drive system configured for steerably moving the mobile robot within a working environment, and a control system configured for controlling the drive system to move the mobile robot autonomously along a path defined in a coordinate map of the working environment. The control system is further configured to dynamically update the path to avoid detected obstacles and projections of detected obstacles that intrude within a defined free space of the mobile robot. Correspondingly, the control system is configured to generate said projections of detected obstacles based on, for each such projection, detecting a moving obstacle that meets defined minimum speed and persistence requirements, estimating a speed and direction of the moving obstacle based on tracking changes in its detected location over successive detection cycles, and marking a corresponding swath of map coordinates or grid cells ahead of the moving obstacle as being occupied for purposes of obstacle avoidance processing by the mobile robot.

A corresponding example method for operating a mobile robot autonomously moving along a path defined in a coordinate map of the working environment includes dynamically updating the path to avoid detected obstacles and projections of detected obstacles that intrude within a defined free space of the mobile robot, and generating said projections of detected obstacles. Each such projection is based on detecting a moving obstacle that meets defined minimum speed and persistence requirements, estimating a speed and direction of the moving obstacle based on tracking changes in its detected location over successive detection cycles, and marking a corresponding swath of map coordinates or grid cells ahead of the moving obstacle as being occupied for purposes of obstacle avoidance processing by the mobile robot.

In another example, a method of operation in a mobile robot includes detecting obstacles within a sensory range of the mobile robot while autonomously moving along a planned path defined in a coordinate map representing a working environment of the mobile robot. Detection in this context is based on acquiring and evaluating sensor readings from one or more sensors of the mobile robot in each of an ongoing succession of detection cycles.

For static detected obstacles, the method includes generating first occupancy data that marks coordinates in the coordinate map corresponding to the detected obstacle locations as being occupied. For moving detected obstacles that meet one or more qualifications, the method includes generating second occupancy data that marks coordinates in the coordinate map corresponding to the detected obstacle locations as being occupied, and, for each such obstacle, further marks as being occupied coordinates in the coordinate map corresponding to a projection of the obstacle having a direction and extent determined from tracking the obstacle over successive ones of the detection cycles. The example method further includes dynamically updating the planned path of the mobile robot in each detection cycle, at least within a range defined for local path re-planning, to avoid map coordinates marked as being occupied.

In a counterpart apparatus example, a mobile robot includes one or more sensors, a drive system, and a control system and associated interface circuitry. The control system and associated interface circuitry are configured to detect obstacles within a sensory range of the mobile robot while autonomously moving along a planned path defined in a coordinate map representing a working environment of the mobile robot. Detection is based on acquiring and evaluating sensor readings from the one or more sensors of the mobile robot in each of an ongoing succession of detection cycles, and correspondingly controlling the drive system.

Further, for static detected obstacles, the control system is configured to generate first occupancy data that marks coordinates in the coordinate map corresponding to the detected obstacle locations as being occupied. For moving detected obstacles that meet one or more qualifications, the control system is configured to generate second occupancy data. The second occupancy data marks coordinates in the coordinate map corresponding to the detected obstacle locations as being occupied, and, for each such obstacle, further marks as being occupied coordinates in the coordinate map corresponding to a projection of the obstacle having a direction and extent determined from tracking the obstacle over successive ones of the detection cycles. Still further, the control system is configured to dynamically update the planned path of the mobile robot in each detection cycle, at least within a range defined for local path re-planning, to avoid map coordinates marked as being occupied.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of one embodiment of a mobile robot.

FIG. 2 is a diagram of one embodiment of an environment map.

FIG. 3 is a diagram of one embodiment of projecting occupancy data for tracked obstacles.

FIG. 4 is a logic flow diagram of one embodiment of a method of dynamic obstacle avoidance.

FIG. 5 is a logic flow diagram of another embodiment of a method of dynamic obstacle avoidance.

FIGS. 6A, 6B, and 6C are diagrams of one embodiment of correlating detected obstacle locations across successive object detection cycles by a mobile robot.

FIG. 7 is a logic flow diagram of another embodiment of a method of dynamic obstacle avoidance.

FIG. 8 is a diagram of functional processing elements, units, or modules of a mobile robot, for performing dynamic obstacle avoidance, such as may be programmatically instantiated in digital processing circuitry via the execution of stored computer program instructions.

### DETAILED DESCRIPTION

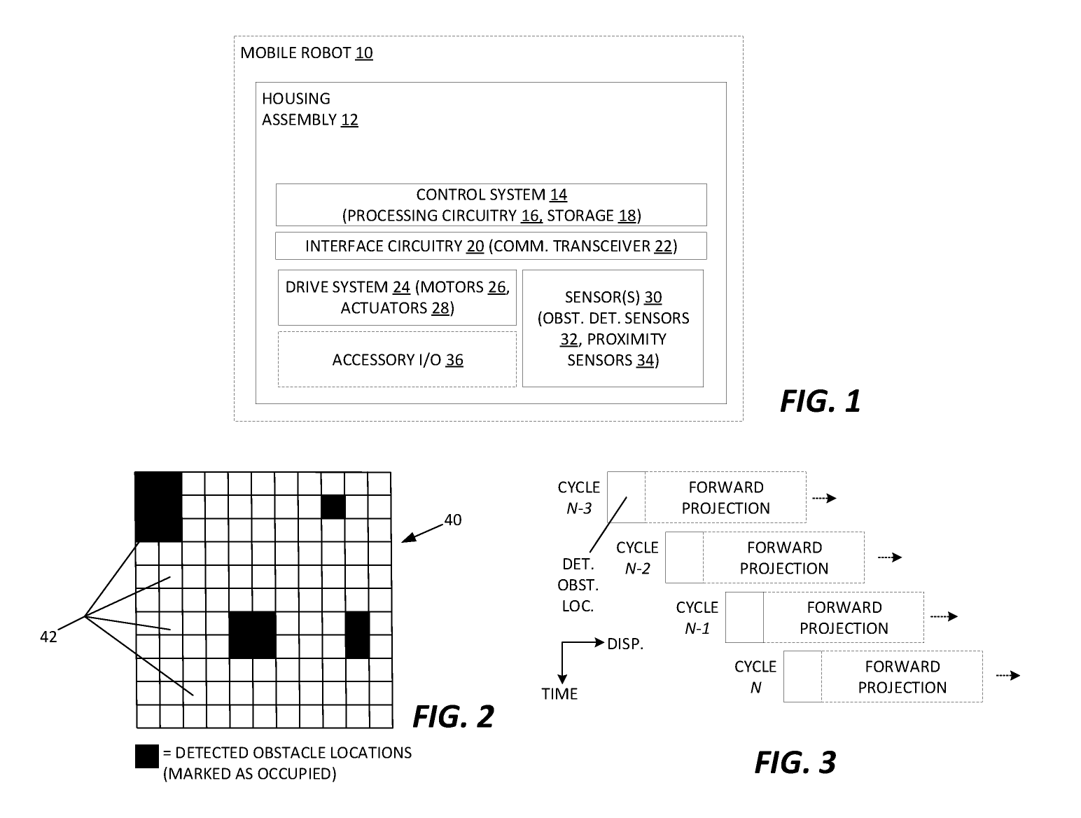

FIG. 1 illustrates one embodiment of a mobile robot 10 (“robot 10”). In the illustrated example, the robot 10 includes a housing assembly or body 12, which houses or otherwise provides mounting points for the constituent components of the robot 10. Notable components include a control system 14, e.g., comprising processing circuitry 16 and storage 18, along with associated interface circuitry 20, which includes a communication transceiver 22 in one or more embodiments. A power supply, such as based on a rechargeable battery carried within the housing assembly 12, may also be included, but are not shown in the diagram.

The interface circuitry 20 interfaces the control system 14 to a drive system 24 that includes, e.g., one or more motors 26 and actuators 28, for steerably moving the robot within a working environment. The robot 10 further includes one or more sensors 30, e.g., including one or more obstacle detection sensors 32 and proximity sensors 34. As with the drive system 24, the control system 14 interfaces with the sensor(s) 30 via the interface circuitry 20, which may be distinct, or which may be respectively integrated in the control system 14, the drive system 24, and the sensor(s) 30. The robot 10 also may include accessory input/output circuitry 36, such as relay out connections, discrete signal outputs, etc.

The processing circuitry 16 of the control system 14 comprises programmed circuitry or fixed circuitry, or any combination of fixed and programmed circuitry. In an example embodiment, the processing circuitry 16 comprises one or more microprocessors, Digital Signal Processors (DSPs), Field Programmable Gate Arrays (FPGAs), or Application Specific Integrated Circuits (ASICs), or any mix thereof. At least a portion of such circuitry is obtained or realized based on one or more processors executing computer program instructions stored in a computer-readable medium (or media) included in the robot 10. For example, the storage 18 includes working and program memory used to store a computer program or programs for execution by one or more processors.

The interface circuitry 20 provides the control system 14 with monitoring and control access to various other components of the robot 10. The interface circuitry 20 comprises, for example, discrete analog and/or digital I/O, and may include one or more data and control bus interfaces, signal isolation or level-shifting circuits, transducer circuits, and other such circuitry as is known for providing computer-based control of electromechanical systems that include motors, sensors, etc.

The sensors 30 comprise, for example, one or more camera-based sensors, one or more ultrasonic sensors, and/or one or more scanning-laser based sensors. In at least one embodiment, the sensors comprise two or more LIDAR assemblies configured for scanning a sector along the front of the robot 10. In such implementations, the LIDAR assemblies provide raw sensor data representing return reflections of the emitted laser light, where such data comprises angular scanning angle and time-of-flight information for example. Such data may be preprocessed into 3D range map or point cloud data, that includes range pixels or data points.

With such preprocessing, detected objects appear as clusters of associated pixels or data points. These data points may be translated into map coordinates in a coordinate map stored by the robot 10. For example, the robot 10 holds a coordinate map representing the working environment in which the robot operates, with the coordinate map comprising a dense grid of X,Y coordinates representing corresponding points in the working environment. The coordinate map also may comprise or be used to define grid cells, where each grid cell contains a range of such X,Y coordinates.

FIG. 2 depicts an example coordinate map 40, or at least a portion of such a map. For example, FIG. 2 may be understood as depicting that portion of an overall map 40 that is within the sensory range of the robot 10. Further, FIG. 2 may be understood as depicting one detection cycle or “snapshot” taken by the robot 10 during operation, which is another way of saying that the illustration is an example depiction of what the robot 10 might detect during a given obstacle detection cycle. In one such cycle, the control system 14 acquires sensor data from the obstacle detection sensors 32, processes the sensor data to detect obstacles—e.g., cluster processing of laser point cloud data—and translates the detected obstacle locations into the map coordinate system. No scale is intended or implied for the map 40 or its coordinate subdivisions 42, nor for the detected obstacle locations shown after translation into the map coordinate system.

The overall map 40 represents a working environment of the robot 10, e.g., a factory floor, warehouse, hospital, or other building, facility, or area, using a potentially fine grid of X,Y coordinates 42. Each square in the diagram may be regarded as a distinct coordinate point in the map 40. While the map depiction is simplified for illustration, the actual map 40 stored in the robot 10 may include many grid coordinates, depending upon the base resolution adopted for the map 40 and the physical extents of the working area represented by the map 40.

In one example, the coordinate grid adopts a 70-millimeter resolution. It should also be understood that the robot 10 may work with different coordinate resolutions at different times, or for different types of processing. For example, when planning or updating a path for autonomous movement through the working environment, the robot 10 may use a grid cell concept for at least some aspects of obstacle detection and/or path planning and updating. A “grid cell” spans a defined range of X and Y coordinates and provides a mechanism for the robot 10 to operate at coarser resolutions than the underlying grid of coordinates that define the map 40.

The map 40 may include predefined obstacle locations, referred to as known obstacle locations (not shown in the diagram). Path planning by the robot 10 accounts for the known obstacle locations by planning a path through the coordinate map that avoids the known obstacle locations. For such purposes, the robot 10 may store occupancy data in or in logical association with the map 40 that marks the corresponding map coordinates or the involved grid cells as being occupied. Thus, the robot 10 plans a global path going from one point to another in the map 40 that threads through or around all known obstacles, such as walls, fixed equipment, etc. As the robot 10 moves along the planned path however, it carries out ongoing obstacle detection, to detect static and moving obstacles present in the working environment, and it dynamically updates its path as needed, to avoid encroaching on detected obstacle locations.

When “avoiding” detected obstacles, the robot 10 may apply minimum clearance requirements, meaning that it avoids map coordinates associated with detected obstacle locations, plus some additional allowance for clearance. Further in this regard, there may be a defined “free space” around the robot, or at least defined within the sensory view of the robot 10. The free space represents the area within which the robot 10 dynamically re-plans its path, as needed, in view of detected obstacle locations. Obstacles detected beyond the free space of the robot 10 do not trigger path re-planning, in at least some embodiments of the robot 10.

Thus, a basic aspect of the path planning algorithm of the robot 10, as implemented via the processing of sensor data by the control system 14, involves dynamically updating the planned path of the robot 10, as needed to avoid map coordinates or grid cells that are marked as occupied, at least to the extent that such coordinates or cells fall within the free space of the robot 10. Of course, the free space moves along with the robot 10, meaning that a detected obstacle not currently encroaching the free space may later encroach the free space.

According to additional pre-processing implemented by the control system 14, the path planning algorithm is made responsive to moving obstacles in a way that obtains sophisticated path adaptation by the robot 10, without encumbering the path planning algorithm with additional complexity. That is, the control system 14 implements a clever mechanism for dynamically updating the planned path in a way that avoids computational complexity in the path planning algorithm, while simultaneously imbuing the robot 10 with a sophisticated control response to moving detected obstacles.

FIG. 3 introduces a basic aspect of such control by depicting an incrementally changing detected obstacle location (“DET. OBST. LOC.”) over a succession of detection cycles, going from a current detection cycle N backwards in time through prior detection cycles N−1, N−2, and N−3. For discussion purposes, one may assume that these detected obstacle locations correspond to a moving obstacle that has already been flagged for tracking by the control system 14. One may also assume that each DET. OBST. LOC. box depicted in FIG. 3 is represented in the processing flow of the control system 14 as a collection of grid coordinates or grid cells of the coordinate map 40 that are correspondingly marked as being occupied in the then-current detection cycle, for purposes of path planning for obstacle avoidance.

Further, in each detection cycle, the control system 14 makes a forward projection from the currently detected obstacle location, based on marking as occupied the grid coordinates or grid cells that are in the projected path of the obstacle being tracked. The control system 14 determines the path projection based on the estimates of speed and direction it maintains for each moving obstacle it tracks. The control system 14 may also account for the detected (apparent) size of the obstacle in its path projections, meaning that the direction, length, and width of the path projection derive from its estimates of movement direction, movement speed, and object size, for the object being tracked. Alternatively, the control system 14 may use a default width for projections, or at least impose a minimum width for projections.

Of course, the control system 14 must be configured to recognize which detected obstacle locations, as detected in a current detection cycle, correspond with previously detected obstacle locations. Correlation processing provides a mechanism for associating changing obstacle locations across detection cycles as being attributable to a moving object rather than being interpreted as disjointed, static obstacle detections. In at least some embodiments, the control system 14 is configured to interrelate a series of changing obstacle locations detected over a succession of detection cycles as “snapshots” of a moving obstacle, based on correlation processing that accounts for estimated speed and direction.

With the preceding example details in mind, in at least some embodiments, the control system 14 is configured for controlling the drive system 24 to move the robot 10 autonomously along a path defined in a coordinate map 40 of the working environment. Moreover, the control system 14 is configured to dynamically update the path to avoid detected obstacles and projections of detected obstacles that intrude within a defined free space of the robot 10. For such operation, the control system 14 is configured to generate said projections of detected obstacles based on, for each such projection, detecting a moving obstacle that meets defined minimum speed and persistence requirements, estimating a speed and direction of the moving obstacle based on tracking changes in its detected location over successive detection cycles, and marking a corresponding swath of map coordinates or grid cells ahead of the moving obstacle as being occupied for purposes of obstacle avoidance processing—path planning—by the robot 10.

In an example configuration, the robot 10 acquires new sensor data or sets of sensor data ten times per second, with each acquisition marking the start of a detection cycle. Each such cycle includes processing the newly acquired sensor data, to identify detected obstacles, and relating such detections both to known obstacle locations, e.g., predefined in the coordinate map, and to previously detected obstacle locations, e.g., as seen in one or more prior detection cycles. Of course, the example case of a 10 Hz detection cycle is not limiting. Depending on the maximum rate of travel of the robot 10 and the known or expected speed(s) of other objects moving in its environment, the robot 10 may use a faster or slower detection cycle.

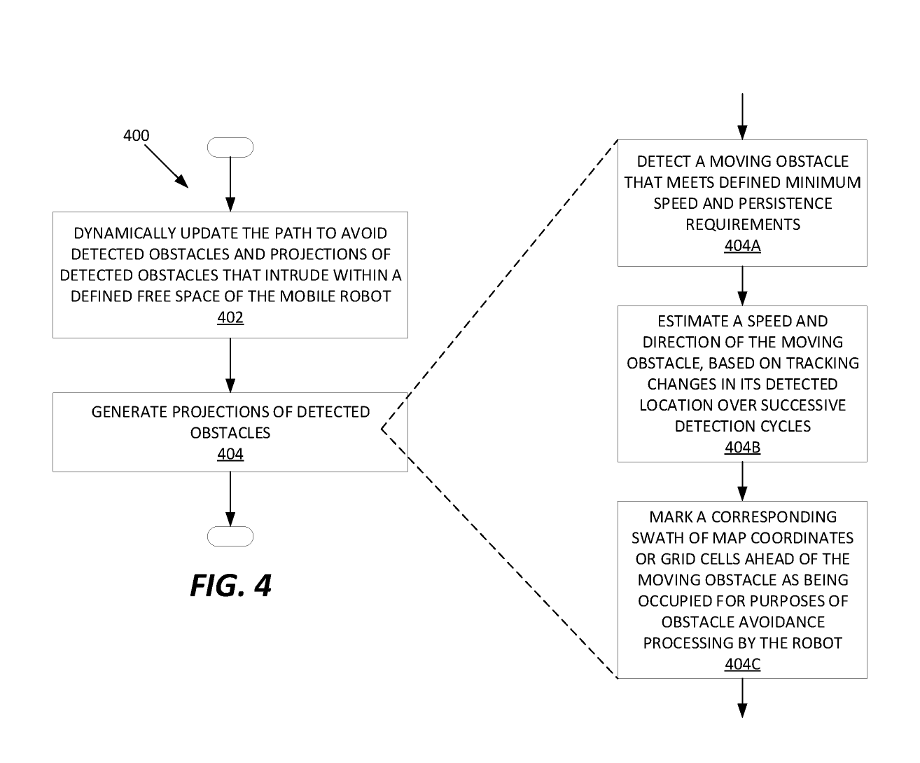

FIG. 4 illustrates an example method 400 of operating the robot 10 as it moves autonomously along a path defined in the map 40. The method 400 may be performed in an order different than what may be suggested by the illustration. Further, at least some aspects of the illustrated operations may be performed as background processing, in parallel, or on an ongoing or looped basis, and certain operations may be applied on a per-obstacle basis. In an example, some or all the method 400 repeats on a per detection cycle basis.

The method 400 includes dynamically updating (Block 402) the path of the robot 10 to avoid detected obstacles and projections of detected obstacles that intrude within a defined free space of the robot 10, and generating (Block 404) such projections according to a set of operations that includes, for each such projection, detecting (Block 404A) a moving obstacle that meets defined minimum speed and persistence requirements.

Projection processing continues with the control system estimating (Block 404B) a speed and direction of the moving obstacle, based on tracking changes in its detected location over successive detection cycles. Updating the estimates in each cycle, based on a running filter or other such processing improves such estimations, if the actual speed and direction of the tracked obstacle are not changing rapidly. The control system 14 uses the current estimates of speed and direction to mark (Block 404C) a corresponding swath of map coordinates or grid cells ahead of the moving obstacle as being occupied for purposes of obstacle avoidance processing by the control system 14.

Such processing can be understood as “feeding” the path planning algorithm in each detection cycle with both actual detected locations and “synthetic” detected locations. The occupancy data representing each tracked obstacle projection is synthetic in the sense that involved map coordinates were not actually detected as being occupied, but are marked as occupied to reflect predicted future locations of the tracked obstacle. The synthesis of occupancy data may remain substantially transparent to the path planning algorithm, which means that the use of projections in this manner can be understood as an advantageous way of imbuing the robot 10 with sophisticated object-avoidance behavior regarding moving obstacles, without need for modifying the robot's underlying path planning algorithm. The approach, therefore, provides an efficient mechanism for integrating both dynamic and static obstacle avoidance into the robot's behavior.

In the above context, the “minimum persistence requirement” may be defined as a requirement that an obstacle must be detected as a moving obstacle for some minimum number of detection cycles, before the control system 14 decides to classify and track the detected obstacle as a “tracked object” for purposes of generating projections of it. In such embodiments of the control system 14, obstacles not detected as moving with at least some minimum speed over some minimum number of detected cycles are not treated as “tracked obstacles” by the control system 14, meaning that the control system 14 does not maintain speed and direction estimates for them and does not generate corresponding projections. Of course, path planning still accounts for the actual detected locations of such obstacles, at least to the extent that such locations encroach within the range or distance used to trigger dynamic path updating.

In another example embodiment, the control system 14 and associated interface circuitry 20 are configured to detect obstacles within a sensory range of the robot 10, while the robot 10 moves autonomously along a planned path defined in a coordinate map, such as the map 40, representing a working environment of the robot 10. Such movement is based on acquiring and evaluating sensor readings from the one or more sensors 30 of the robot 10 in each of an ongoing succession of detection cycles, and correspondingly controlling the drive system 24.

For static detected obstacles, the control system 14 is configured to generate first occupancy data that marks coordinates in the map 40 corresponding to the detected obstacle locations as being occupied. For moving detected obstacles that meet one or more qualifications, the control system 14 is configured to generate second occupancy data that marks coordinates in the map 40 corresponding to the detected obstacle locations as being occupied, and, for each such obstacle, further marks as being occupied coordinates in the map 40 corresponding to a projection of the obstacle having a direction and extent determined from tracking the obstacle over successive ones of the detection cycles.

Still further, the control system 14 is configured to dynamically update the planned path of the mobile robot in each detection cycle, at least within a range defined for local path re-planning, to avoid map coordinates marked as being occupied. Such behavior can be understood as feeding the path planning algorithm with actual data corresponding to detected obstacles, and with synthetic data corresponding to predicted paths of moving obstacles being tracked by the robot 10. Path planning responds in the same manner to the actual and synthetic data, in that it dynamically recalculates the path as needed, to avoid encroaching on map locations marked as occupied.

In an example implementation, the control system 14 is configured to track each moving detected obstacle that meets the one or more qualifications as a tracked obstacle, based on maintaining a Kalman filter instance for each tracked obstacle and using the Kalman filter instance in each detection cycle to predict a next obstacle location for the next detection cycle. The control system 14 is configured to update each Kalman filter instance in each detection cycle based on an observed displacement between a prior detected obstacle location attributed to the corresponding tracked obstacle in the prior detection cycle and a currently detected obstacle location attributed to the corresponding tracked obstacle in a current detection cycle.

For such processing, the control system is configured to determine whether a currently detected obstacle location can be attributed to a corresponding tracked obstacle by determining whether the currently detected obstacle location sufficiently correlates with the predicted next location of the corresponding tracked obstacle, as predicted in the prior detection cycle. Responsive to determining that no currently detected obstacle location can be attributed to the corresponding tracked obstacle, the control system 14 is configured to increase a tracking uncertainty value associated with the corresponding tracked obstacle.

The control system 14 uses the tracking uncertainty value for deciding when to terminate tracking of corresponding tracked obstacle. Once the tracking uncertainty exceeds a defined threshold, the control system 14 decides that it cannot make usefully reliable predictions about the next location(s) of the tracked obstacle, and thus terminates tracking. From a processing perspective, such termination may include deleting or nulling the corresponding Kalman filter instance and any data structures, indexes, flags, and the like, used to represent a tracked obstacle within the processing flow of the control system 14.

As examples of the one or more qualifications used in the above processing, the control system 14 may use a minimum speed qualification that prevents a given detected obstacle from being processed as a moving detected obstacle unless an estimated speed of the given detected obstacle exceeds a minimum speed. The control system 14 may, additionally or alternatively, use a minimum tracking reliability qualification that causes the control system 14 to terminate tracking of a given moving detected obstacle responsive to an associated tracking uncertainty exceeding a maximum uncertainty value, said maximum uncertainty value representing a maximum uncertainty associated with predicting future locations of the given moving detected obstacle. Still further, the control system 14 may initially detect an obstacle as moving and then confirm its movement over, say two or three further detection cycles, before flagging it for treatment as a tracked obstacle and instantiating the associated tracking data structures for it.

As for path updating, the control system 14 in one or more embodiments is configured to dynamically update the planned path of the robot 10 in each detection cycle, at least within the range defined for local path re-planning. Updating includes revising the planned path at least within the range defined for local path re-planning to avoid map coordinates, or corresponding map grid cells, that are marked as being occupied, subject to one or more minimum obstacle clearance requirements configured in the robot 10.

In further details for an example implementation, the control system 14 is configured to distinguish between static detected obstacles and moving detected obstacles by comparing detected obstacle locations from cycle to cycle, over successive detection cycles, to recognize correlated sets of detected obstacle locations. Each such correlated set comprises a series of two or more successively detected obstacle locations having relative displacements characteristic of an obstacle moving at or above a minimum speed. Movement tracking, for example, may consider linear or curvilinear obstacle movements.

For comparing the detected obstacle locations from cycle to cycle, over successive detection cycles, the control system 14 may be configured to develop speed and direction estimates for detected obstacles perceived by the robot 10 to be moving detected obstacles, and use the speed and direction estimates to correlate the detected obstacle locations across the successive evaluation cycles. For example, the speed estimate defines the expected displacement between the detected obstacle location in a current detection cycle, and the detected obstacle location in the prior detection cycle, while the direction estimate defines the expected direction of displacement.

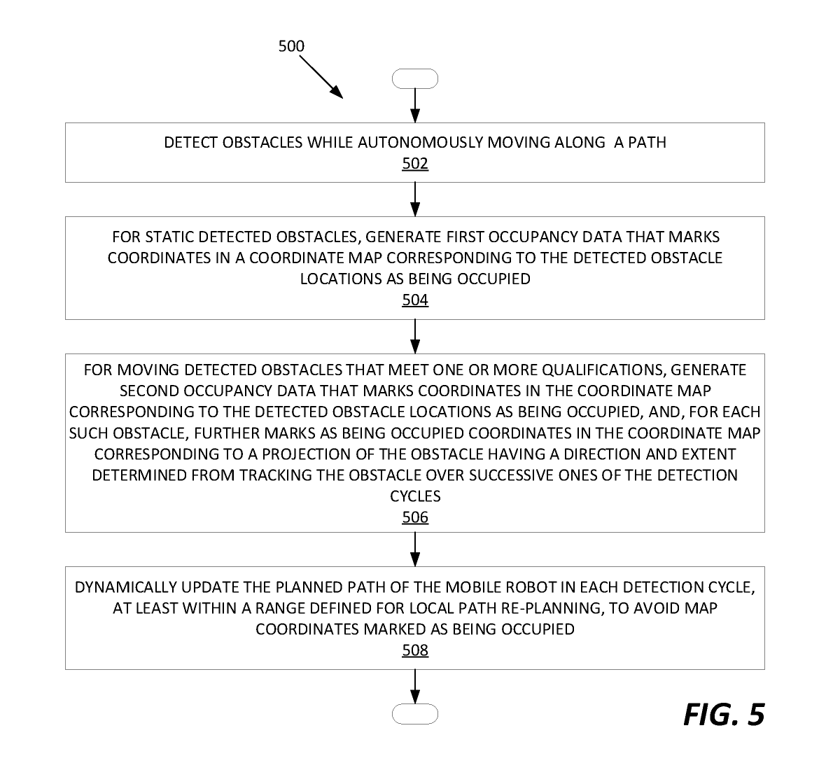

FIG. 5 illustrates an example method 500 of operation for a mobile robot, e.g., the robot 10 introduced in FIG. 1. The method 500 may be performed in an order different than what may be suggested by the illustration. Further, at least some aspects of the illustrated operations may be performed as background processing, in parallel, or on an ongoing or looped basis, and certain operations may be applied on a per-obstacle basis. In an example, some or all the method 500 repeats on a per detection cycle basis.

The method 500 includes detecting (Block 502) obstacles within a sensory range of the mobile robot while autonomously moving along a planned path defined in a coordinate map 40 representing a working environment of the robot 10. Such movement is based on acquiring and evaluating sensor readings from one or more sensors 30 of the robot 10 in each of an ongoing succession of detection cycles.

For static detected obstacles, the method 500 includes generating (Block 504) first occupancy data that marks coordinates in the coordinate map corresponding to the detected obstacle locations as being occupied. For moving detected obstacles that meet one or more qualifications, the method 500 includes generating (Block 506) second occupancy data that marks coordinates in the coordinate map corresponding to the detected obstacle locations as being occupied, and, for each such obstacle, further marks as being occupied coordinates in the coordinate map corresponding to a projection of the obstacle having a direction and extent determined from tracking the obstacle over successive ones of the detection cycles. Correspondingly, the method 500 further includes dynamically updating (Block 508) the planned path of the robot 10 in each detection cycle, at least within a range defined for local path re-planning, to avoid map coordinates marked as being occupied.

Tracking each moving detected obstacle that meets the one or more qualifications as a tracked obstacle may be based on the control system 14 of the robot 10 maintaining a Kalman filter instance for each tracked obstacle and using the Kalman filter instance in each detection cycle to predict a next obstacle location for the next detection cycle. Updating each Kalman filter instance in each detection cycle relies on, for example, an observed displacement between a prior detected obstacle location attributed to the corresponding tracked obstacle in the prior detection cycle and a currently detected obstacle location attributed to the corresponding tracked obstacle in a current detection cycle.

Determining whether a currently detected obstacle location can be attributed to the corresponding tracked obstacle comprises, for example, determining whether the currently detected obstacle location sufficiently correlates with the predicted next location of the corresponding tracked obstacle, as predicted in the prior detection cycle. Upon determining that none of the currently detected obstacle locations can be attributed to a tracked obstacle, the method 500 includes, for example, increasing a tracking uncertainty value associated with the tracked obstacle, where said tracking uncertainty value is used by the robot 10 as a decision parameter for deciding when to stop tracking the tracked obstacle.

As noted, the robot 10 may not track a moving obstacle for purposes of generating obstacle projections unless the obstacle is determined to meet one or more qualifications. In the context of the method 500, such minimum qualifications comprise, for example, at least one of a minimum speed qualification that prevents a given detected obstacle from being processed by the mobile robot as a moving detected obstacle unless an estimated speed of the given detected obstacle exceeds a minimum speed, and a minimum tracking reliability qualification. The minimum tracking reliability qualification causes the mobile robot to terminate tracking of a given moving detected obstacle responsive to an associated tracking uncertainty exceeding a maximum uncertainty value. The maximum uncertainty value represents a maximum uncertainty associated with predicting future locations of the given moving detected obstacle.

Dynamically updating the planned path of the robot 10 in each detection cycle comprises, for example, revising the planned path at least within the range defined for local path re-planning to avoid map coordinates, or corresponding map grid cells, that are marked as being occupied, subject to one or more minimum obstacle clearance requirements configured in the robot 10. Also, as noted, distinguishing between static detected obstacles and moving detected obstacles may be based on comparing detected obstacle locations from cycle to cycle, over successive detection cycles, to recognize correlated sets of detected obstacle locations, each such correlated set comprising a series of two or more successively detected obstacle locations having relative displacements characteristic of an obstacle moving at or above a minimum speed.

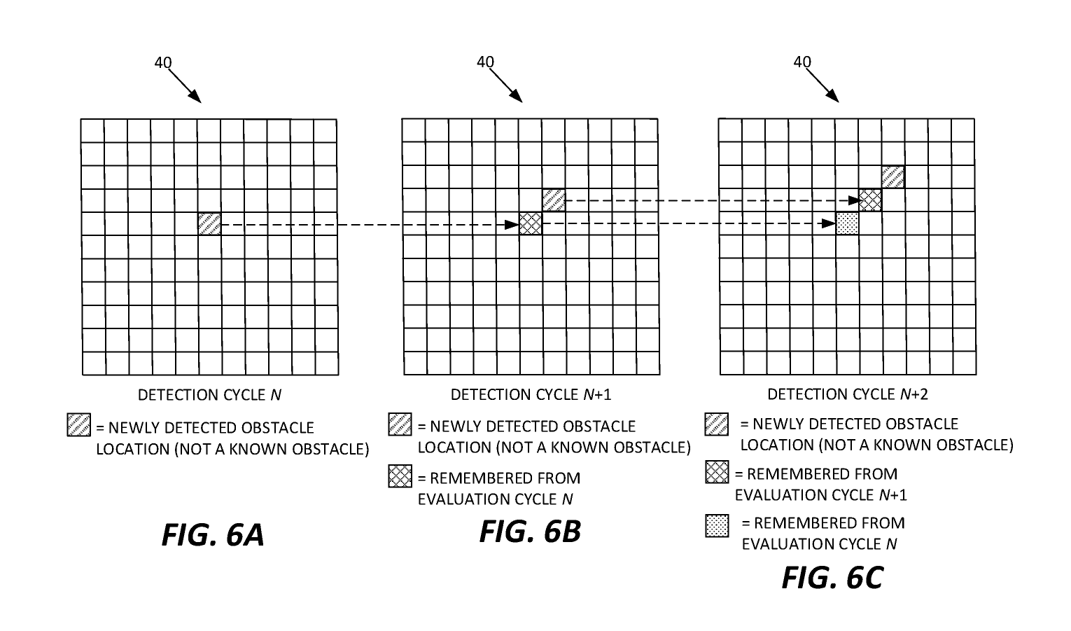

Comparing the detected obstacle locations from cycle to cycle, over successive detection cycles, includes developing speed and direction estimates for detected obstacles perceived by the mobile robot to be moving detected obstacles, and using the speed and direction estimates to correlate the detected obstacle locations across the successive evaluation cycles. See FIGS. 6A, 6B, and 6C, for example.

FIGS. 6A-6C depict at least a robot-viewable portion of the map 40, over three detection cycles, starting with a current detection cycle N and going forward in time over succeeding detection cycles N+1 and N+2. In the current detection cycle N, the robot 10 detects a new obstacle—i.e., one not seen in a prior detection cycle and one not known from any fixed-obstacle configuration information stored for the map 40. One may assume for purposes of this illustration that the location of the newly detected obstacle does not correlate with any previously detected obstacle locations, i.e., the new obstacle is the initial or first-time detection of the underlying obstacle in question.

The control system 14 remembers the location of the newly detected obstacle in terms of the involved map coordinates, which provides it a basis detection evaluation in the next detection cycle N+1. In the N+1 detection cycle, the location associated with the previous detection N is empty but the control system 14 detects another new obstacle at a nearby location in the map 40. Based on the absence of the previously detected obstacle and the presence of a newly detected obstacle in proximity to the prior location, the control system 14 at least tentatively deems the involved obstacle to be a moving obstacle and attributes both the previously detected (cycle N) and currently detected (cycle N+1) locations to it.

In the N+2 detection cycle, the location associated with the previous detection N+1 is empty but the control system 14 detects another new obstacle at a nearby location in the map 40. Based on the absence of the previously detected obstacle and the presence of a newly detected obstacle that is in proximity to the prior location and consistent with the tentative direction of travel observed over the N and N+1 detection cycles, the control system 14 confirms that it is observing the changing location of a moving obstacle and marks the obstacle for tracking, if the observed rate of movement meets any minimum object speed qualifies in force by the control system 14.

As a further practical example, a mobile robot configured for autonomous movement in a working environment is configured to detect moving obstacles and predict the expected motion of these obstacles to use with the path planning algorithm implemented by the mobile robot. As a non-limiting example, the mobile robot in question is the robot 10 introduced in FIG. 1.

Among the numerous benefits accruing to the robot 10 because of the contemplated configuration, the robot 10 exhibits smoother motion in pedestrian traffic, and when exposed to forklifts, or any other moving vehicles. The involved processing predicts the future positions of objects moving in the same space as the robot 10 to avoid collisions in a more predictable way, which is more comfortable for people operating in the robot's working environment. For example, in a conventional implementation, a robot may continue along its planned path and cross in front of a person or vehicle moving perpendicularly towards the planned path. However, based on the observed speed of the person or vehicle, the robot 10 responds to the predicted future location(s)—the projection—of the person or vehicle and, for example, slows down so that it passes behind the person or vehicle.

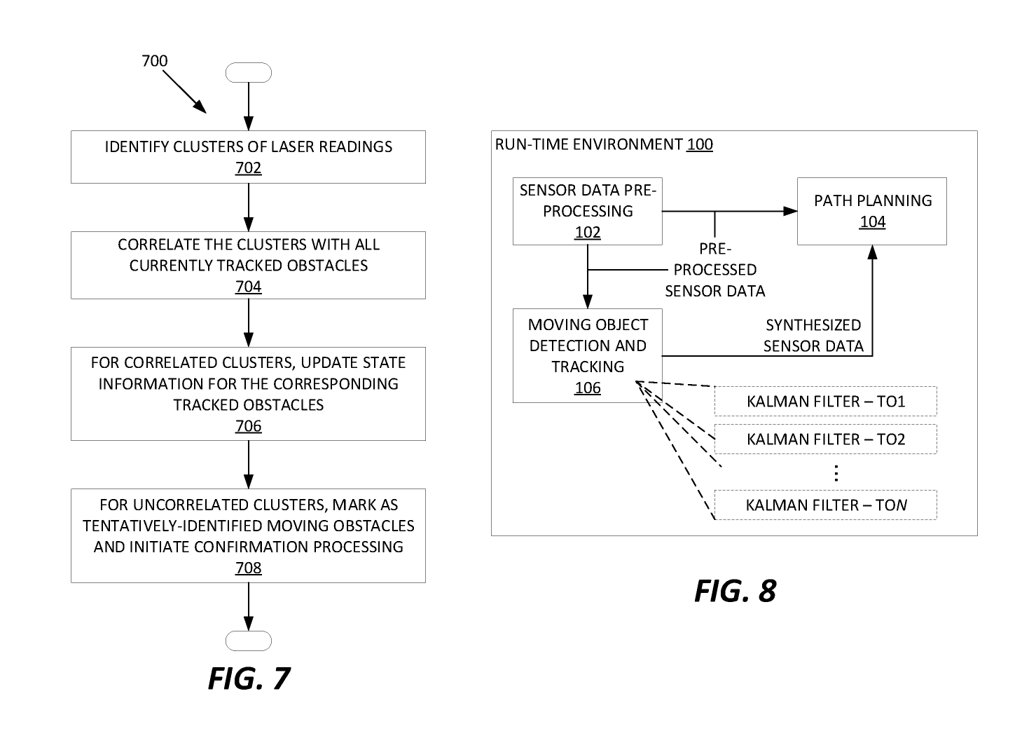

FIG. 7 illustrates a method 700 of dynamic obstacle avoidance, with the method being understood as a variation or more detailed example of the previously illustrated methods 400 and 500. The method 700 presumes that the obstacle detection sensors 32 of the robot 10 comprise one or more scanning lasers, and the method 700 further presumes that the phrase “currently tracked obstacles” denotes all moving obstacles that have been detected and qualified for tracking by the robot 10.

The method 700 reflects at least a portion of the processing carried out in each detection cycle of the robot 10, and includes identifying clusters of laser readings (Block 702). In this context, an obstacle physically present within the applicable sensor fields-of-view will manifest itself as a cluster of laser readings, with the control system 14 being configured to recognize such clusters as representing detected obstacles.

The control system 14 correlates the currently-detected clusters with all currently tracked obstacles (Block 704). Such processing may comprise, for example, the control system 14 converting the clusters into map coordinates and determining whether the location of any cluster matches the currently-predicted location of any tracked obstacle. Any such matching locations are considered to be correlated with the predicted/past locations of the involved tracked objects and are used to update the state information for the involved tracked objects—e.g., update the speed and direction estimates (Block 706).

Conversely, the control system 14 marks uncorrelated clusters—i.e., clusters that do not correlate with any currently tracked obstacles—as tentatively-identified moving obstacles and initiates confirmation processing for them (Block 708). In other words, for these newly identified obstacle locations, the control system 14 remembers them for carrying forward into succeeding detection cycles, for processing along the lines exemplified in FIGS. 6A-6C.

Accordingly, in each detection cycle, the robot 10 detects clusters of laser readings that are real obstacles in its working environment, correlates the clusters of laser readings over two or more detection cycles, to confirm the presence of moving obstacles that should be considered in path planning. Correspondingly, the robot 10 sends the currently-detected locations of such obstacles to path planning, along with their corresponding projections.

In further example detail, as a first step in each detection cycle, the robot 10 uses a two-dimensional scanning laser operating parallel to the floor to obtain the locations of detected obstacles with their position determined in the map coordinates stored in the robot's memory. Of course, the robot 10 may use other sensor types and configurations for obstacle detection, such as a three-dimensional laser-based detection assembly, a stereo camera-based detection assembly, etc.

However detected, the detected obstacle positions are expressed in map coordinates using an appropriate sensor-to-map coordinate transform. The robot 10 compares the detected obstacle locations to the map 40, and, using a “stored occupancy grid” representing fixed obstacles known a priori in the working environment, all detected obstacle locations matching pre-stored obstacles are ignored, for purposes of moving obstacle detection and tracking. (Such locations are accounted for in the path planning operations.)

The robot 10 uses a second occupancy grid to further reduce the incorrect tracking of static obstacles. Static obstacles can mistakenly be tracked due to uncertainty in the sensor as well as through a change in perspective by the robot motion, and the robot 10 uses the second occupancy grid to guard against such errors. The second occupancy grid has cells (corresponding to subsets of map coordinates) that are increased by some value for every location that contains a laser reading while every other cell is decremented without going below zero. If a location contains a number greater than some threshold, the robot 10 considers that location as being occupied by a static obstacle. Again, for purposes of moving obstacle detection and tracking, obstacles detected and confirmed to be static are ignored (but are considered in path planning and updating).

After filtering out the laser readings that were identified as representing fixed, pre-stored obstacles or confirmed static obstacles, the remaining laser readings are clustered into groups, with each group representing a detected obstacle. The clustering is performed using an open-list nearest neighbor calculation. By open-list, the idea is that “the neighbor of my neighbor is my neighbor.” Once these clusters are calculated, the robot 10 checks them for their approximate maximum dimension. A cluster can, optionally, be ignored if its size is greater than some threshold. The robot 10 may also evaluate the clusters and, for example, ignore any clusters having fewer than some minimum number of laser readings.

More broadly, or in at least some embodiments, a cluster may be rejected if its size does not fall within a predefined range. Other shape-based constraints may also be implemented, such as qualifying or otherwise evaluating clusters based on their aspect ratio. These approaches provide relatively simple mechanisms for eliminating false positives, especially when the types of expected obstacles are limited, and their shape properties are known.

In any case, to correlate the clusters remaining after any such qualification or filtering processing with all currently-tracked obstacles—moving obstacles already detected and qualified by the robot 10 for tracking and trajectory prediction—the robot 10 compares the location in map coordinates of each such cluster to all predicted obstacle locations in the current detection cycle. Each predicted obstacle location represents the expected location of a tracked obstacle in the current detection cycle, with each such prediction made by extrapolating from the last obstacle location attributed to the tracked obstacle, using the speed and direction estimates maintained by the robot 10 for the tracked obstacle.

For processing purposes, in one or more embodiments, the robot 10 represents each tracked obstacle as an instance of a Kalman filter with a motion that is a nearly-constant velocity with a small, predefined, deceleration term. For each tracked obstacle, the obstacle location in the current detection cycle that is attributed to the tracked obstacle is provided for the observation update step of the corresponding Kalman filter instance. That is, the detected obstacle location that is attributed (via correlation processing) to a tracked obstacle serves as the basis for updating the Kalman filter instance maintained for the tracked obstacle.

An uncertainty of the obstacle location is calculated by the Kalman filter. If a tracked obstacle is not observed in the current detection cycle, meaning no cluster or laser readings correlates with it in the current detection cycle, then only the motion model prediction is performed, and the uncertainty of the obstacle increases.

A correlated observation on the next iteration could reduce the uncertainty of the obstacle location, e.g., depending on the strength of the correlation. Here, correlation strength may be expressed or understood as reflecting the degree to which a currently detected obstacle location matches the predicted location of a tracked obstacle for the current detection cycle. If an obstacle uncertainty is greater than some threshold, the robot 10 considers the tracked obstacle as “lost,” meaning that the robot 10 no longer has reliable tracking of the obstacle. In response to losing track of an obstacle, the robot 10 removes its Kalman filter instance from the list of tracked obstacles. Further, as the robot 10 tracks obstacles, it maintains an “age” parameter relative to the detection cycle at which tracking was commenced.

To determine if a laser cluster correlates with a tracked obstacle, the robot 10 first compares the cluster to the tracked obstacle that is closest to the cluster using its center-to-center distance. That tracked obstacle has some uncertainty determined as part of its Kalman filter representation. A distance threshold that is proportional to the uncertainty is used to determine if the cluster of laser readings correlates with the tracked obstacle. If the distance between the laser cluster and the tracked obstacle's predicted location is less than the threshold, that laser cluster is considered as being correlated with the tracked obstacle. If the distance between the laser cluster and that tracked obstacle is larger than the threshold, the process is repeated using the next closest tracked obstacle.

If a cluster of laser readings does not correlate with any tracked obstacles according to the above processing, it is assumed to be a new obstacle in the working environment of the robot 10 and a new tracked obstacle is at least tentatively created at the position of the laser cluster. Of course, the above correlation may be based on other evaluations than the nearest-neighbor approach described. Further, other correlation methods may be used on an additional basis, as a way to include additional characteristics or score the methods on further parameters. The availability of these additional comparison/correlation metrics can be used to optimize the correlation-based assessments.

For example, the detected obstacle size could be considered in combination with the position. Determining a “matching probability” between a cluster of laser readings and a tracked obstacle could then generate a scoring metric, with the robot 10 comparing the scores of a laser cluster relative to multiple tracked obstacles, when attempting to determine the best match in cases where there is at least some threshold level of correlation between the cluster and more than one tracked obstacle.

After all tracked obstacles are updated with their observations and newly tracked obstacles are made, the robot 10 decides whether these tracked obstacles should be considered by the path planning. If a tracked obstacle is newly created and has not reached a threshold for its minimum age, the tracked obstacle and its predicted trajectory should not be considered by the path planning algorithm of the robot 10 until the tracked obstacle has been tracked for the threshold length of time—which time may be measured in terms of detection cycles.

The robot 10 also may compare the speed of each tracked obstacle to a configurable threshold, i.e., some minimum speed qualification. If the observed speed is below that threshold, the tracked obstacle should not be considered by the path planning, or, more specifically, the robot 10 may be configured to avoid making projections for moving detected obstacles unless the observed speed of such obstacles meets a minimum qualification threshold. This approach makes sense because projections for very slow-moving obstacles may not add any useful input to the path planning algorithm, and because the path planning algorithm necessarily already considers detected static obstacles. However, it is contemplated that in some embodiments, the robot 10 does not impose minimum-speed qualifications for tracking obstacles and projecting their future locations, for purposes of path planning.

In another example, consider a scenario where the robot 10 operates among a fleet of robots that are centrally managed by a computer server or other computing apparatus operating as a “fleet manager.” In such contexts, the robot 10 may plan paths between starting and ending locations in the coordinate map, as provided to it by the fleet manager via wireless signaling handled by the communication transceiver 22 of the robot 10. The communication transceiver 22 may be configured, e.g., for a standardized or proprietary radio communication protocol, for such operations.

In the fleet context, tracked obstacle processing by the robot 10 may consider fleet information provided to it by the fleet manager. For example, the robot 10 receives the locations of the other robots from the fleet manager. The robot 10 compares tracked obstacle locations against reported locations of other robots to determine whether any obstacle being tracked by the robot 10 is, in fact, another robot in the fleet.

In at least some embodiments, the robot 10 does not consider other robots in its path planning, e.g., it does not generate projections for them and does not feed occupancy data representing such projections into the path planning algorithm. Indeed, in at least some embodiments, the robot 10 filters out detected obstacle locations that represent other robots before sending obstacle detection data to the path planning algorithm. Such approaches reflect the fact that the fleet manager may be in a better position to jointly coordinate and control robot movement, e.g., based on centrally known priorities, etc.

In a further example of fleet-manger coordination, the fleet manager provides better motion by prioritizing the individual robots in the fleet. When a robot is a higher priority than another, the path of the higher priority robot is sent to the robot with lower priority. This path information makes the robot with lower priority avoid the robot with higher priority, while the robot with higher priority does not try to avoid the lower priority robot. If the higher-priority robot applied dynamic obstacle tracking as detailed herein, both the lower-priority and higher-priority robots could take evasive action and their corresponding path adjustments could inadvertently result in a collision or cause a series of erratic, disjointed path adjustments by the involved robots. Prioritization can thus be understood as settling which robot shall take evasive action when two robots are on conflicting paths.

A relevant example involves a computer system configured as a fleet manager for a plurality of autonomous mobile robots. The computer system comprises, for example, a network appliance or other network-linked node that includes one or more communication interfaces for direct, wireless communication with the mobile robots comprising the managed fleet. Additionally, or alternatively, the node includes one or more computer-network interfaces that couple it to a radio module or supporting node that communicatively couples the node to the fleet of mobile robots.

The fleet manager in one embodiment carries out a method of operation for managing dynamic obstacle avoidance by mobile robots in the fleet, which comprises, for example, the fleet manager receiving obstacle-detection information from respective ones of the mobile robots and providing a first given mobile robot with obstacle-detection information that is relevant to its current location and derived from obstacle-detection information reported by one or more other given mobile robots. As such, the fleet manager may report to one robot 10 moving-obstacle information, based on moving-obstacle detection information reported by another robot 10.

In any case, for tracked obstacles that are used by a robot 10 to generate projections fed into the path planning algorithm as synthesized occupancy data, the robot 10 uses the currently-detected obstacle location attributed to the tracked obstacle and the positions along its trajectory (derived from the corresponding speed and direction estimates) to generate the “second occupancy data” mentioned in Block 506 of the method 500 illustrated in FIG. 5. The trajectory of the tracked obstacle is predicted by taking the current estimated velocity, and the projection comprises some number of projected future positions—which may form a contiguous projection. As a working example, the robot 10 bases its projections on a two-second window. Thus, for a tracked obstacle having an estimated speed of 1 m/s to the right, the robot 10 generates the corresponding projection as a set of obstacles beginning at the tracked obstacle's current location and ending at 2 meters to the right of the tracked obstacle's current location.

With this trajectory, the robot 10 can more safely plan a path from its current location to some defined goal without crossing the trajectories of the tracked obstacle, thereby providing safety for people or other vehicles. The control system 14 of the robot 10 may also be configured to check all tracked obstacle projections, to prevent them from overlapping with the robot's current location, because synthesizing laser readings into the current location of the robot 10 would cause the robot 10 to make an emergency stop.

FIG. 8 illustrates one embodiment of a run-time environment 100, such as may be instantiated via the processing circuitry 16 of the control system 14. In the illustrated example, the processing circuitry 16 instantiates or otherwise functionally implements a sensor data pre-processing module 102, a path planning module 104, and a moving object detection and tracking module 106.

The sensor data pre-processing module 102 is configured, for example, to process the raw data incoming from the sensors 30, e.g., laser readings from a laser-based assembly used by the robot 10 for obstacle detection. Such pre-processing may include, e.g., the above-described clustering and associated processing of laser readings.

The moving object detection and tracking module 106 is configured, for example, to detect moving obstacles as described above, and to determine which such obstacles to track as tracked obstacles for purposes of obstacle projection. As such, the moving object detection and tracking module 106 is configured in one or more embodiments to instantiate a Kalman filter instance—or other data structure for obstacle tracking—for each obstacle being tracked by the control system 14. In the example, one sees Kalman filter instances for tracked obstacles (TOs) 1 . . . N. Of course, the number and respective “ages” of the Kalman filter instances will depend on the number of moving obstacles and their attributes within the sensory range of the robot 10.

The robot 10 in one or more embodiments is configured to “share” certain moving obstacle information, e.g., with one or more other robots that may or may not be of the same type. For example, the robot 10 transmits information identifying the moving obstacles that it is currently tracking, optionally along with pertinent information such as last-detected location, trajectory projection, etc. The robot 10 may share this information by transmitting the tracking data structures or their included contents, being used for the currently-tracked set of obstacles, or it may transmit selected information from such data structures. Notably, obstacle location (current or predicted) may be shared in terms of map coordinates, so that location is commonly expressed and understood by all involved robots.

The transmission of information regarding tracked obstacles may be accomplished in unicast, multi-cast, or broadcast fashion. For example, the robot 10 detects or has knowledge of the other robots that are operating in its vicinity, and it sends one or more targeted transmissions, e.g., using corresponding radio or network identifiers. Here, a “targeted transmission” is not necessarily directionally steered in a radio beam sense, but does carry information that addresses the transmissions to particular robots or groups of robots. Alternatively, the robot 10 may make a generalized transmission that reports its location and provides information regarding its currently tracked obstacles, and other robots can decide whether such information is relevant, based on their respective locations and paths. As a further alternative, the robot 10 reports such information to a centralized node or management computer, which then makes the information generally available or selectively available to other robots.

In a complementary operation, at least some embodiments of the robot 10 are configured to receive tracked-obstacle information directly or indirectly from one or more “offboard” detection systems. The offboard detection systems may be, for example, laser- or camera-based obstacle detection systems fixedly installed at given locations within the working environment of the robot 10. Additionally, or alternatively, the offboard detection systems are, or include, one or more other robots, e.g., other mobile robots operating in the working environment of the robot 10. Such information may be received directly from the offboard detection systems, or may be relayed or otherwise transmitted to the mobile robot 10 via, e.g., a centralized node having a wireless communication link to the mobile robot 10.

In at least one such embodiment, the robot 10 is configured to use offboard detection information in its own processing for moving obstacle detection. For example, the robot 10 may reduce the time or number of evaluation cycles over which it qualifies a newly detected obstacle for tracking as a moving obstacle, based on determining that the newly detected obstacle matches the information reported by an offboard detection system—e.g., matching in one or more of size, speed, trajectory, and location (detected or predicted).

The mobile robot 10 may receive obstacle-detection information for the area of the map in which it is currently operating, or for one or more areas of the map relevant to its planned path. The mobile robot 10 in at least some embodiments receives offboard obstacle detection information and uses it in its obstacle-detection and moving-obstacle qualification and tracking, as detailed above.

With the above examples in mind, rather than associating a risk or collision probability for each dynamic obstacle, the example methods and apparatuses described herein represent a dynamic obstacle's projected path as a virtual obstacle. The location and dimensions of the virtual obstacle are determined first by the detection of the actual obstacle, and subsequently by a projection process. While there is a measure of uncertainty associated with each projected dynamic obstacle location, the uncertainty value is used to establish whether the projected location is sufficiently accurate for the virtual obstacle to be included in the coordinate map. In other words, the uncertainty value leads to a binary decision about whether to include the virtual obstacle in the coordinate map, and not a probability value.

Among the several advantages of the contemplated approach, it is computationally efficient not least because it eliminates the overhead of calculating a collision risk or probability based on a multivariate probability distribution. Further, the disclosed methods and apparatus improve efficiency in mobile robot operation by planning a robot's path considering only the spatial coordinates. In comparison, methods that use the probability and temporal components add significant complexity. Moreover, by frequently re-planning the path with the virtual obstacles, the disclosed approach adjusts to changes quickly, therefore reducing computational requirements without sacrificing safety, quality and overall performance. Still further, the disclosed approach provides an unambiguous representation of the operating space around a mobile robot that is straightforward to interpret, both by computer-controlled autonomous robots and human operators that may need to remain appraised of mobile-robot activities.

Notably, modifications and other embodiments of the disclosed invention(s) will come to mind to one skilled in the art having the benefit of the teachings presented in the preceding descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method of operation in a mobile robot comprising:
detecting obstacles within a sensory range of the mobile robot while autonomously moving along a planned path defined in a coordinate map representing a working environment of the mobile robot, based on acquiring and evaluating sensor readings from one or more sensors of the mobile robot in each of an ongoing succession of detection cycles;
for static detected obstacles, generating first occupancy data that marks coordinates in the coordinate map corresponding to the detected obstacle locations as being occupied;
for moving detected obstacles that meet one or more qualifications, generating second occupancy data that marks coordinates in the coordinate map corresponding to the detected obstacle locations as being occupied, and, for each such obstacle, further marks as being occupied coordinates in the coordinate map corresponding to a projection of the obstacle having a direction and extent determined from tracking the obstacle over successive ones of the detection cycles; and
dynamically updating the planned path of the mobile robot in each detection cycle, at least within a range defined for local path re-planning, to avoid map coordinates marked as being occupied.

2. The method of claim 1, further comprising tracking each moving detected obstacle that meets the one or more qualifications as a tracked obstacle, based on maintaining a Kalman filter instance for each tracked obstacle and using the Kalman filter instance in each detection cycle to predict a next obstacle location for the next detection cycle.

3. The method of claim 2, further comprising updating each Kalman filter instance in each detection cycle, based on an observed displacement between a prior detected obstacle location attributed to the corresponding tracked obstacle in the prior detection cycle and a currently detected obstacle location attributed to the corresponding tracked obstacle in a current detection cycle.

4. The method of claim 3, further comprising determining whether a currently detected obstacle location can be attributed to the corresponding tracked obstacle by determining whether the currently detected obstacle location sufficiently correlates with the predicted next location of the corresponding tracked obstacle, as predicted in the prior detection cycle, and, responsive to determining that none of the currently detected obstacle locations can be attributed to the corresponding tracked obstacle, increasing a tracking uncertainty value associated with the corresponding tracked obstacle, said tracking uncertainty value used by the mobile robot as a decision parameter for deciding when to stop tracking the corresponding tracked obstacle.

5. The method of claim 1, wherein the one or more qualifications comprise at least one of a minimum speed qualification that prevents a given detected obstacle from being processed by the mobile robot as a moving detected obstacle unless an estimated speed of the given detected obstacle exceeds a minimum speed, and a minimum tracking reliability qualification that causes the mobile robot to terminate tracking of a given moving detected obstacle responsive to an associated tracking uncertainty exceeding a maximum uncertainty value, said maximum uncertainty value representing a maximum uncertainty associated with predicting future locations of the given moving detected obstacle.

6. The method of claim 1, wherein dynamically updating the planned path of the mobile robot in each detection cycle, at least within the range defined for local path re-planning, comprises revising the planned path at least within the range defined for local path re-planning to avoid map coordinates, or corresponding map grid cells, that are marked as being occupied, subject to one or more minimum obstacle clearance requirements configured in the mobile robot.

7. The method of claim 1, further comprising distinguishing between static detected obstacles and moving detected obstacles by comparing detected obstacle locations from cycle to cycle, over successive detection cycles, to recognize correlated sets of detected obstacle locations, each such correlated set comprising a series of two or more successively detected obstacle locations having relative displacements characteristic of an obstacle moving at or above a minimum speed.

8. The method of claim 7, wherein comparing the detected obstacle locations from cycle to cycle, over successive detection cycles, includes developing speed and direction estimates for detected obstacles perceived by the mobile robot to be moving detected obstacles, and using the speed and direction estimates to correlate the detected obstacle locations across the successive evaluation cycles.

9. The method of claim 1, wherein detecting obstacles within the sensory range of the mobile robot comprises detecting obstacles via at least one of: one or more detectors based on camera imaging, one or more detectors based on ultrasonic sensing, and one or more detectors based on scanning laser detection.

10. The method of claim 1, wherein the moving detected obstacles that meet the one or more qualifications are referred to as tracked obstacles, and, for each moving detected obstacle currently being tracked by the mobile robot as a tracked obstacle, the method comprises wirelessly transmitting corresponding tracked-obstacle data.

11. The method of claim 10, wherein the corresponding tracked-obstacle data comprises map location and trajectory information.

12. The method of claim 1, further comprising wirelessly receiving obstacle-detection information directly or indirectly from one or more offboard obstacle detection systems operating in the working environment of the mobile robot, the obstacle-detection information comprising one or both of obstacle location and trajectory information, for one or more moving obstacles detected by one or more of the one or more offboard obstacle detection systems, and wherein the method further comprises deciding whether a moving detected obstacle, as detected by the mobile robot, should be tracked by the mobile robot, at least in part on whether or to what extent the moving detected obstacle matches obstacle location and trajectory information included in the obstacle-detection information received by the mobile robot.

13. A mobile robot comprising:
one or more sensors;
a drive system; and
a control system and associated interface circuitry configured to:
detect obstacles within a sensory range of the mobile robot while autonomously moving along a planned path defined in a coordinate map representing a working environment of the mobile robot, based on acquiring and evaluating sensor readings from the one or more sensors of the mobile robot in each of an ongoing succession of detection cycles, and correspondingly controlling the drive system;
for static detected obstacles, generate first occupancy data that marks coordinates in the coordinate map corresponding to the detected obstacle locations as being occupied;
for moving detected obstacles that meet one or more qualifications, generate second occupancy data that marks coordinates in the coordinate map corresponding to the detected obstacle locations as being occupied, and, for each such obstacle, further marks as being occupied coordinates in the coordinate map corresponding to a projection of the obstacle having a direction and extent determined from tracking the obstacle over successive ones of the detection cycles; and
dynamically update the planned path of the mobile robot in each detection cycle, at least within a range defined for local path re-planning, to avoid map coordinates marked as being occupied.

14. The mobile robot of claim 13, wherein the control system is configured to track each moving detected obstacle that meets the one or more qualifications as a tracked obstacle, based on maintaining a Kalman filter instance for each tracked obstacle and using the Kalman filter instance in each detection cycle to predict a next obstacle location for the next detection cycle.

15. The mobile robot of claim 14, wherein the control system is configured to update each Kalman filter instance in each detection cycle, based on an observed displacement between a prior detected obstacle location attributed to the corresponding tracked obstacle in the prior detection cycle and a currently detected obstacle location attributed to the corresponding tracked obstacle in a current detection cycle.

16. The mobile robot of claim 15, wherein the control system is configured to determine whether a currently detected obstacle location can be attributed to a corresponding tracked obstacle by determining whether the currently detected obstacle location sufficiently correlates with the predicted next location of the corresponding tracked obstacle, as predicted in the prior detection cycle, and, responsive to determining that no currently detected obstacle location can be attributed to the corresponding tracked obstacle, increasing a tracking uncertainty value associated with the corresponding tracked obstacle, said tracking uncertainty value used by the mobile robot for deciding when to terminate tracking of corresponding tracked obstacle.

17. The mobile robot of claim 13, wherein the one or more qualifications comprise at least one of a minimum speed qualification that prevents a given detected obstacle from being processed by the mobile robot as a moving detected obstacle unless an estimated speed of the given detected obstacle exceeds a minimum speed, and a minimum tracking reliability qualification that causes the mobile robot to terminate tracking of a given moving detected obstacle responsive to an associated tracking uncertainty exceeding a maximum uncertainty value, said maximum uncertainty value representing a maximum uncertainty associated with predicting future locations of the given moving detected obstacle.

18. The mobile robot of claim 13, wherein the control system is configured to dynamically update the planned path of the mobile robot in each detection cycle, at least within the range defined for local path re-planning, by revising the planned path at least within the range defined for local path re-planning to avoid map coordinates, or corresponding map grid cells, that are marked as being occupied, subject to one or more minimum obstacle clearance requirements configured in the mobile robot.

19. The mobile robot of claim 13, wherein the control system is configured to distinguish between static detected obstacles and moving detected obstacles by comparing detected obstacle locations from cycle to cycle, over successive detection cycles, to recognize correlated sets of detected obstacle locations, each such correlated set comprising a series of two or more successively detected obstacle locations having relative displacements characteristic of an obstacle moving at or above a minimum speed.

20. The mobile robot of claim 19, wherein, for comparing the detected obstacle locations from cycle to cycle, over successive detection cycles, the control system is configured to develop speed and direction estimates for detected obstacles perceived by the mobile robot to be moving detected obstacles, and use the speed and direction estimates to correlate the detected obstacle locations across the successive evaluation cycles.

21. The mobile robot of claim 13, wherein the one or more sensors comprise at least one of: one or more detectors based on camera imaging, one or more detectors based on ultrasonic sensing, and one or more detectors based on laser scanning.

22. The mobile robot of claim 13, wherein the moving detected obstacles that meet the one or more qualifications are referred to as tracked obstacles, and, for each moving detected obstacle currently being tracked by the mobile robot as a tracked obstacle, the control system is configured to wirelessly transmit corresponding tracked-obstacle data.

23. The mobile robot of claim 22, wherein the corresponding tracked-obstacle data comprises map location and trajectory information.

24. The mobile robot of claim 13, wherein the control system is configured to wirelessly receive obstacle-detection information directly or indirectly from one or more offboard obstacle detection systems operating in the working environment of the mobile robot, the obstacle-detection information comprising one or both of obstacle location and trajectory information, for one or more moving obstacles detected by one or more of the one or more offboard obstacle detection systems, and wherein the control system is further configured to decide whether a moving detected obstacle, as detected by the mobile robot, should be tracked by the mobile robot, at least in part on whether or to what extent the moving detected obstacle matches obstacle location and trajectory information included in the obstacle-detection information received by the mobile robot.

25. A mobile robot comprising one or more sensors configured for detecting obstacles within a defined sensory range of the mobile robot, a drive system configured for steerably moving the mobile robot within a working environment, and a control system configured for controlling the drive system to move the mobile robot autonomously along a path defined in a coordinate map of the working environment, the control system being further configured to:
dynamically update the path to avoid detected obstacles and projections of detected obstacles that intrude within a defined free space of the mobile robot; and
generate said projections of detected obstacles based on, for each such projection, detecting a moving obstacle that meets defined minimum speed and persistence requirements, estimating a speed and direction of the moving obstacle based on tracking changes in its detected location over successive detection cycles, and marking a corresponding swath of map coordinates or grid cells ahead of the moving obstacle as being occupied for purposes of obstacle avoidance processing by the mobile robot.

26. A method of operating a mobile robot autonomously moving along a path defined in a coordinate map of the working environment, the method comprising:
dynamically updating the path to avoid detected obstacles and projections of detected obstacles that intrude within a defined free space of the mobile robot; and generating said projections of detected obstacles based on, for each such projection:
detecting a moving obstacle that meets defined minimum speed and persistence requirements;
estimating a speed and direction of the moving obstacle based on tracking changes in its detected location over successive detection cycles;
marking a corresponding swath of map coordinates or grid cells ahead of the moving obstacle as being occupied for purposes of obstacle avoidance processing by the mobile robot.

27. A method performed by a computer system configured as a fleet manager for a plurality of autonomous mobile robots, for managing dynamic obstacle avoidance by the plurality of mobile robots, the method comprising:
receiving obstacle-detection information from respective ones of the mobile robots; and
providing a first given mobile robot with obstacle-detection information that is relevant to a current location of the first given mobile robot and derived from obstacle-detection information reported by one or more other given mobile robots.
